(19) United States
(12) Patent Application Publication
(10) Pub. No.: US 2021/0001248 A1
(43) Pub. Date: Jan. 7, 2021

(54) RESERVOIR TANK

(71) Applicant: TIGERS POLYMER CORPORATION, Osaka (JP)

(72) Inventors: Shunsuke SAKATA, Hyogo (JP); Eiji TSUGUI, Hyogo (JP)

(21) Appl. No.: 16/910,464

(22) Filed: Jun. 24, 2020

(30) Foreign Application Priority Data
Jul. 3, 2019 (JP) 2019-124309
Jul. 10, 2019 (JP) 2019-128711

(51) Int. Cl. B01D 19/00

(52) U.S. Cl. CPC B01D 19/0057

(57) ABSTRACT

A reservoir tank includes: a tank chamber for storing a cooling fluid; a gas-liquid separation chamber provided adjacently below the tank chamber in a vertical direction; a partition wall for partitioning the tank chamber and the gas-liquid separation chamber; an inflow pipe for sending the cooling fluid into the reservoir tank; and a discharge pipe for discharging the cooling fluid from the reservoir tank. The inflow pipe and the discharge pipe are connected to the gas-liquid separation chamber, the partition wall is provided with a communication hole that communicates the tank chamber and the gas-liquid separation chamber, the reservoir tank is provided with a suction hole that communicates the tank chamber and the discharge pipe, or a suction hole that communicates the tank chamber and a vicinity of the discharge pipe in the gas-liquid separation chamber, and the reservoir tank is configured such that a flow rate of the cooling fluid in the discharge pipe or in the gas-liquid separation chamber at a position where the suction hole is provided is higher than the flow rate of the cooling fluid in the gas-liquid separation chamber at a position where the communication hole is provided.

### CROSS-REFERENCE TO RELATED APPLICATION

This application claims priority from Japanese Patent Application No. 2019-124309 filed with the Japan Patent Office on Jul. 3, 2019, and from Japanese Patent Application No. 2019-128711 filed with the Japan Patent Office on Jul. 10, 2019, the entire contents of both of which are hereby incorporated by reference.

### BACKGROUND

### 1. Technical Field

One aspect of the present disclosure relates to a reservoir tank.

### 2. Related Art

Liquid-cooled cooling systems are used for cooling internal combustion engines, electric elements, electronic boards, and the like. In the liquid-cooled cooling system, heat is collected from a member to be cooled by circulating a cooling fluid, and the member to be cooled is cooled by dissipating heat from a heat radiator. In the liquid-cooled cooling system, a cooling fluid tank, that is, the reservoir tank, may be provided in a cooling fluid circuit for circulating the cooling fluid. The reservoir tank is used to compensate for a decrease in the cooling fluid due to vaporization or the like, and to absorb a volume change of the cooling fluid due to a temperature change. When air bubbles are generated in the cooling fluid, cooling efficiency may decrease. Therefore, the bubbles in the cooling fluid may be separated by the reservoir tank, that is, gas-liquid separation may be performed.

For example, in a technique disclosed in JP-A-2005-248753, rectangular baffle plates are arranged in a reservoir tank body so as to have a windmill shape in a specific direction. JP-A-2005-248753 discloses that according to the reservoir tank, the bubbles can be separated from the cooling fluid without increasing water flow resistance and complicating its structure.

### SUMMARY

A reservoir tank includes: a tank chamber for storing a cooling fluid; a gas-liquid separation chamber provided adjacently below the tank chamber in a vertical direction; a partition wall for partitioning the tank chamber and the gas-liquid separation chamber; an inflow pipe for sending the cooling fluid into the reservoir tank; and a discharge pipe for discharging the cooling fluid from the reservoir tank. The inflow pipe and the discharge pipe are connected to the gas-liquid separation chamber, the partition wall is provided with a communication hole that communicates the tank chamber and the gas-liquid separation chamber, the reservoir tank is provided with a suction hole that communicates the tank chamber and the discharge pipe, or a suction hole that communicates the tank chamber and a vicinity of the discharge pipe in the gas-liquid separation chamber, and the reservoir tank is configured such that a flow rate of the cooling fluid in the discharge pipe or in the gas-liquid separation chamber at a position where the suction hole is provided is higher than the flow rate of the cooling fluid in the gas-liquid separation chamber at a position where the communication hole is provided.

### BRIEF DESCRIPTION OF THE DRAWINGS

FIG. 1 is an exploded perspective view illustrating a structure of a reservoir tank of a first embodiment;

FIG. 2 is a cross-sectional view taken along a line X-X shown in FIG. 1, illustrating the structure of the reservoir tank of the first embodiment;

FIG. 3 is a cross-sectional view taken along a line Y-Y shown in FIG. 2, illustrating the structure of the reservoir tank of the first embodiment;

FIG. 4 is a cross-sectional view taken along the line Y-Y shown in FIG. 2, illustrating an operation of the reservoir tank of the first embodiment;

FIG. 5 is a cross-sectional view taken along a line A-A shown in FIG. 4, illustrating the operation of the reservoir tank of the first embodiment;

FIG. 6 is a cross-sectional view taken along the line Y-Y shown in FIG. 2, illustrating the operation of the reservoir tank of the first embodiment;

FIG. 7 is an exploded perspective view illustrating the structure of the reservoir tank according to a second embodiment;

FIG. 8 is a cross-sectional view taken along the line Y-Y shown in FIG. 9, illustrating the operation of the reservoir tank of the second embodiment;

FIG. 9 is a cross-sectional view taken along the line X-X shown in FIG. 7, illustrating the operation of the reservoir tank of the second embodiment;

FIG. 10 is a cross-sectional view taken along the line X-X, illustrating the structure and the operation of the reservoir tank of a third embodiment, and corresponding to FIGS. 2 and 9;

FIG. 11 is a cross-sectional view taken along the line X-X, illustrating the structure and the operation of the reservoir tank of a fourth embodiment, and corresponding to FIGS. 2 and 9;

FIG. 12 is a cross-sectional view taken along the line X-X, illustrating the structure of the reservoir tank of a fifth embodiment, and corresponding to FIGS. 2 and 9;

FIG. 13 is a cross-sectional view taken along the line X-X, illustrating the structure of the reservoir tank of a sixth embodiment, and corresponding to FIGS. 2 and 9; and

FIG. 14 is a cross-sectional view taken along the line A-A, illustrating the structure and the operation of the reservoir tank of the sixth embodiment, and corresponding to FIG. 5.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In recent years, in order to improve performance of a cooling system, there has been a demand for increasing a flow rate of cooling fluid passing through a reservoir tank as disclosed in JP-A-2005-248753. However, it has been found that when the flow rate of the cooling fluid passing through the reservoir tank increases in the reservoir tank as disclosed in JP-A-2005-248753, the cooling fluid flowing into a tank body tends to be undulating and turbulent, and thus air in the tank is easily entrained in the cooling fluid, so that it is difficult to obtain an expected level of gas-liquid separation effect.

One object of the present disclosure is to provide a reservoir tank that can perform a gas-liquid separation while controlling the turbulent surface of the liquid inside the tank body.

As a result of intensive studies, the inventors have found that the above object is achieved by partitioning a gas-liquid separation chamber where a main flow of the cooling fluid flows and a tank chamber with a partition wall, to be arranged up and down in the reservoir tank, by providing a communication hole that penetrates the partition wall in a portion where air bubbles are easily collected in the gas-liquid separation chamber, and by directly or indirectly communicating the tank chamber and a discharge pipe with a suction hole, and thus have completed a technology of the present disclosure.

A reservoir tank according to an aspect of the present disclosure includes: a tank chamber for storing a cooling fluid; a gas-liquid separation chamber provided adjacently below the tank chamber in a vertical direction; a partition wall for partitioning the tank chamber and the gas-liquid separation chamber; an inflow pipe for sending the cooling fluid into the reservoir tank; and a discharge pipe for discharging the cooling fluid from the reservoir tank. The inflow pipe and the discharge pipe are connected to the gas-liquid separation chamber, the partition wall is provided with a communication hole that communicates the tank chamber and the gas-liquid separation chamber, the reservoir tank is provided with a suction hole that communicates the tank chamber and the discharge pipe, or a suction hole that communicates the tank chamber and a vicinity of the discharge pipe in the gas-liquid separation chamber, and the reservoir tank is configured such that a flow rate of the cooling fluid in the discharge pipe or in the gas-liquid separation chamber at a position where the suction hole is provided is higher than the flow rate of the cooling fluid in the gas-liquid separation chamber at a position where the communication hole is provided (first aspect).

In the first aspect, a cross-sectional area of a flow path of the discharge pipe or the gas-liquid separation chamber at the position where the suction hole is provided, which is measured in a cross-section perpendicular to a flow direction of the cooling fluid, is preferably smaller than a cross-sectional area of the gas-liquid separation chamber at the position where the communication hole is provided, which is measured in the cross-section (second aspect).

In the first aspect, a cross-sectional area of a flow path of the discharge pipe or the gas-liquid separation chamber at the position where the suction hole is provided is preferably larger than a cross-sectional area of the suction hole (third aspect).

In the first aspect, a cross-sectional area of the suction hole is preferably smaller than that of the communication hole (fourth aspect).

In any one of the first to the fourth aspects, it is preferable that the gas-liquid separation chamber has a cylindrical wall, and is configured to allow the cooling fluid to flow curved in an arc shape along the wall, to collect air bubbles in the cooling fluid radially inward of the arc, and the communication hole is provided radially inward of the arc (fifth aspect).

In any one of the first to the fifth aspects, it is preferable that a control surface, that controls a flow of the cooling fluid flowing from the gas-liquid separation chamber into the tank chamber through the communication hole and flowing upward of the tank chamber to be a flow in a lateral direction, is provided to face the communication hole at a predetermined interval inside the tank chamber (sixth aspect).

According to the reservoir tank of the first aspect, it is possible to obtain an effect that the gas-liquid separation can be performed while controlling the turbulent surface of the liquid inside the tank body.

Further, in the reservoir tank of the second aspect, the third aspect, and the fourth aspect, it is possible to further enhance the gas-liquid separation effect while controlling the turbulent surface of the liquid.

Further, in the reservoir tank of the fifth aspect, separation of the bubbles in the gas-liquid separation chamber is promoted. Therefore, the gas-liquid separation effect can be further enhanced.

Furthermore, in the reservoir tank of the sixth aspect, it is possible to particularly effectively control the turbulent surface of the liquid inside the tank body.

Hereinafter, embodiments of the present disclosure will be described with reference to the drawings, taking the reservoir tank provided in a liquid-cooled cooling system for an internal combustion engine of an automobile as an example. The technology of the present disclosure is not limited to individual embodiments described below, but may also be implemented as modified embodiments below. Applications of the liquid cooling type cooling system are not limited to the internal combustion engine, but may be applications for cooling an electric element such as a power element and an inverter, and an electric component such as an electronic circuit board.

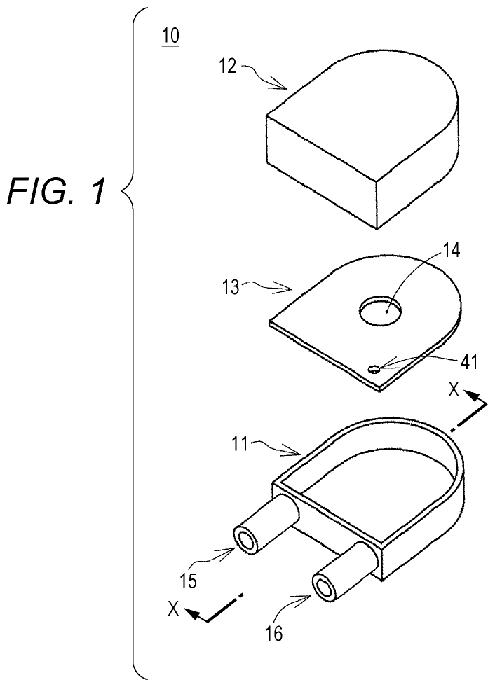

FIGS. 1, 2 and 3 illustrate a structure of a reservoir tank 10 of a first embodiment. FIG. 1 illustrates main members of the reservoir tank 10 in an exploded state using a perspective view. The reservoir tank 10 is configured to include a hollow tank, and an inflow pipe 15 and a discharge pipe 16 connected to the tank. The reservoir tank 10 used in a cooling fluid circuit of the liquid-cooled cooling system is disposed and connected in the cooling fluid circuit of the liquid-cooled cooling system so that the cooling fluid flows from the inflow pipe 15 into the hollow tank, and the cooling fluid flows out of the hollow tank through the discharge pipe 16.

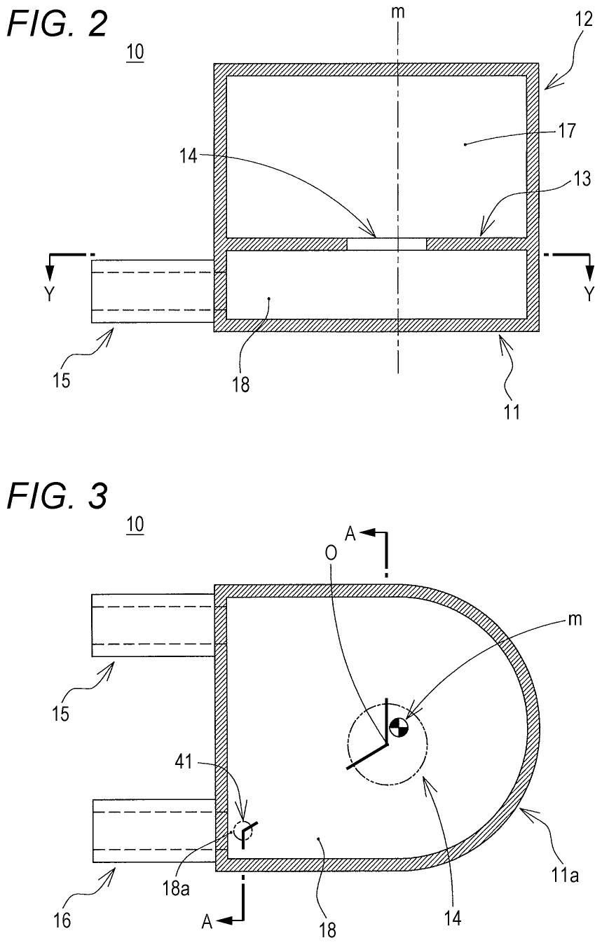

FIG. 2 is a cross-sectional view illustrating a cross-section of the reservoir tank 10 taken along a vertical plane including a line X-X (X-X axis) in FIG. 1. An upper side in FIG. 2 corresponds to the upper side in the vertical direction. FIG. 3 is a cross-sectional view illustrating a cross-section of the reservoir tank 10 taken along a horizontal plane including a line Y-Y (Y-Y axis) in FIG. 2. In the first embodiment, the reservoir tank 10 is formed by integrating a lower case 11, an upper case 12, and a partition wall 13 together. The lower case 11 and the upper case 12 are integrated to form the hollow tank. Such a tank is partitioned by the partition wall 13. In the first embodiment, the partition wall 13 is formed in a flat plate shape. The partition wall 13 extends substantially horizontally and partitions the hollow tank.

An upper room (space) of the hollow tank partitioned by the partition wall 13 is referred to as a tank chamber 17. The cooling fluid is stored in the tank chamber 17. The tank chamber 17 is surrounded by the upper case 12 and the partition wall 13. A lower room (space) of the hollow tank partitioned by the partition wall 13 is referred to as a gas-liquid separation chamber 18. The gas-liquid separation chamber 18 is surrounded by the lower case 11 and the partition wall 13. The gas-liquid separation chamber 18 is provided below the tank chamber 17 in the vertical direction so as to be adjacent to the tank chamber 17 through the partition wall 13.

When the reservoir tank 10 is used, the gas-liquid separation chamber 18 is substantially filled with the cooling fluid. When it is used, most of the space in the tank chamber 17 is filled with the cooling fluid, and the air is stored in an upper portion of the tank chamber 17. That is, the partition wall 13 is arranged such that the whole of the partition wall 13 is immersed in the cooling fluid when used. Although not essential, the lower case 11, the upper case 12, and the partition wall 13 are preferably joined to each other so that the cooling fluid does not easily flow back and forth between the outer peripheral portion of the partition wall 13 and the upper case 12 or the lower case 11.

That is, the reservoir tank 10 provided in the cooling fluid circuit of the liquid-cooled cooling system includes the tank chamber 17 for storing the cooling fluid, the gas-liquid separation chamber 18 provided adjacently below the tank chamber 17 in the vertical direction, the partition wall 13 for partitioning the tank chamber 17 and the gas-liquid separation chamber 18, the inflow pipe 15 for feeding the cooling fluid into the reservoir tank 10, and the discharge pipe 16 for discharging the cooling fluid from the reservoir tank 10. The lower case 11, the upper case 12, the partition wall 13, and the like are assembled so that the structure of the reservoir tank 10 can be realized.

As long as the tank chamber 17 and the gas-liquid separation chamber 18 of the reservoir tank 10 can be formed, a manner of dividing the members for realizing such a structure is not particularly limited. In the first embodiment, the reservoir tank 10 is divided into three members of the lower case 11, the upper case 12, and the partition wall 13. By assembling the members, the structure of the reservoir tank 10 having the tank chamber 17, the gas-liquid separation chamber 18 and the like is realized. In this regard, such a structure may be realized by other members. For example, the tank chamber 17 and the gas-liquid separation chamber 18 may be divided by a vertical plane to form the constituent members, which may be assembled to realize the structure of the reservoir tank 10 having the tank chamber 17, the gas-liquid separation chamber 18 and the like.

The inflow pipe 15 and the discharge pipe 16 are connected to the gas-liquid separation chamber 18. That is, in the reservoir tank 10, the cooling fluid flows into the gas-liquid separation chamber 18 from the inflow pipe 15 and flows out of the gas-liquid separation chamber 18 through the discharge pipe 16. As in the first embodiment, the inflow pipe 15 and the discharge pipe 16 are preferably formed integrally with the lower case 11. Or, the inflow pipe 15 and the discharge pipe 16 may be provided at positions separated from the gas-liquid separation chamber 18. Even in this case, the inflow pipe 15 and the discharge pipe 16 can be connected to the gas-liquid separation chamber 18 by forming a pipe line or a guide plate inside or on an outer periphery of the reservoir tank 10. Even in this case, the reservoir tank 10 can be configured such that the cooling fluid flows into the gas-liquid separation chamber 18 from the inflow pipe 15 and flows out of the gas-liquid separation chamber 18 through the discharge pipe 16. As long as the inflow pipe 15, the discharge pipe 16 and the gas-liquid separation chamber 18 are connected to each other such that the main flow of the cooling fluid substantially flows from the inflow pipe 15 through the gas-liquid separation chamber 18 to the discharge pipe 16, a part of the cooling fluid may flow to other parts.

In the gas-liquid separation chamber 18, the bubbles in the cooling fluid are collected at a predetermined position by action of gravity or the like. The separation of the bubbles in the gas-liquid separation chamber 18 may be realized by other principles such as centrifugal force. Further, the separation of the bubbles and the cooling fluid in the gas-liquid separation chamber 18 does not have to be a complete separation, but the separation is sufficient in which there is a portion where the bubbles are collected more than other parts in the gas-liquid separation chamber 18. As described below, in the first embodiment, the bubbles and the cooling fluid are separated using both the gravity and the centrifugal force in the gas-liquid separation chamber 18. Thus, many bubbles are collected vertically upward, and in a central portion when viewed from the vertical direction in the gas-liquid separation chamber 18.

The partition wall 13 is provided with a communication hole 14 that communicates the tank chamber 17 with the gas-liquid separation chamber 18. That is, between the tank chamber 17 and the gas-liquid separation chamber 18, the cooling fluid, the bubbles, and the air can flow up and down through the communication hole 14.

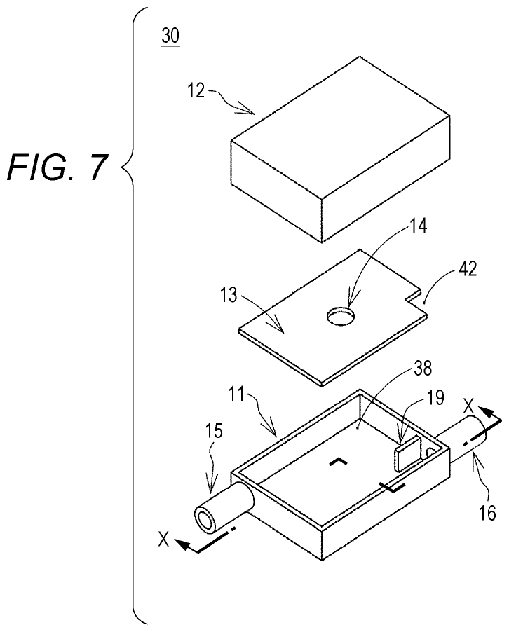

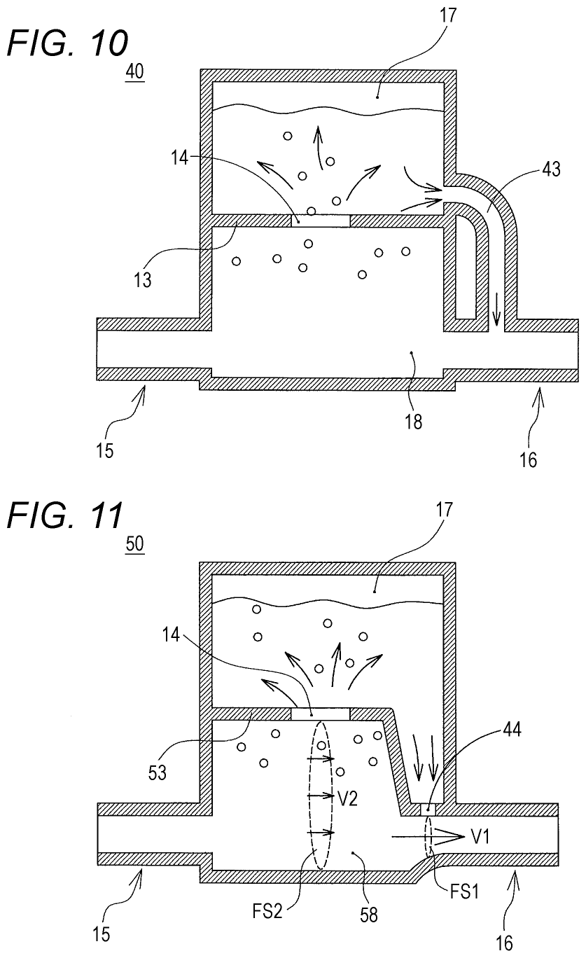

Further, the reservoir tank 10 is provided with a suction hole 41 that communicates the tank chamber 17 and a vicinity 18a of the discharge pipe of the gas-liquid separation chamber 18. Namely, through the suction hole 41 the tank chamber 17 communicates with the gas-liquid separation chamber 18 in the vicinity of the discharge pipe 16. In the first embodiment, the suction hole 41 is provided as a through-hole that penetrates the partition wall 13. Shape of the suction hole 41 is not particularly limited, but may be circular as in the first embodiment. Or, the shape of the suction hole 41 may be rectangular like the suction hole (42, FIG. 7) in other embodiments described below. Or, the suction hole 41 may be provided to have a tubular shape like the suction hole (43, FIG. 10) in other embodiments described below.

In the first embodiment, the suction hole 41 is provided to communicate the vicinity 18a of the discharge pipe of the gas-liquid separation chamber 18 and the tank chamber 17. Instead of this structure, a suction hole that directly communicates the tank chamber 17 and the discharge pipe 16 may be provided as in other embodiments described below (FIG. 10, 11).

With such a structure, the suction hole (suction tube) 41 is located closer to the discharge pipe 16 than the communication hole 14, along the main flow of the cooling fluid flowing from the inflow pipe 15 through the gas-liquid separation chamber 18 to the discharge pipe 16, that is, the suction hole 41 is located downstream of the communication hole 14.

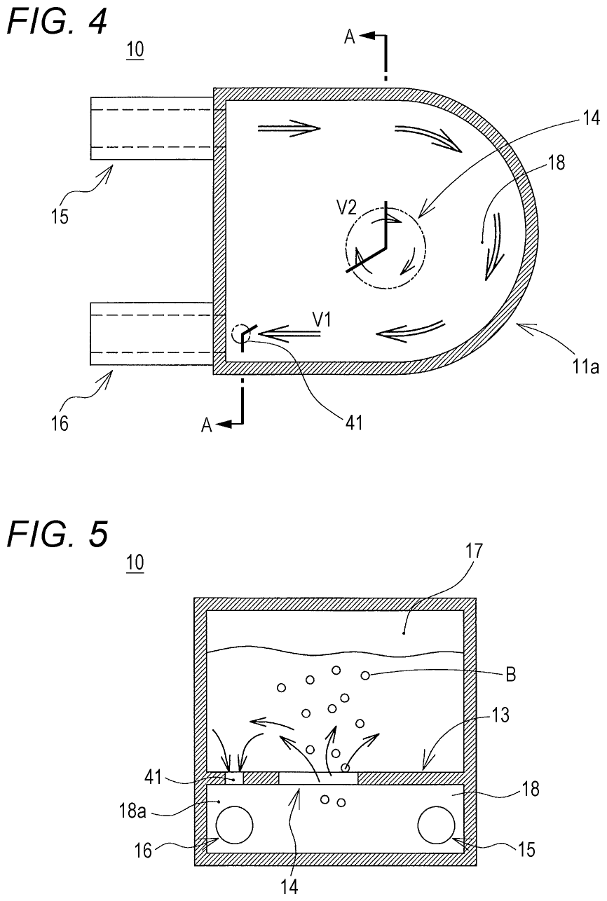

The reservoir tank 10 of the first embodiment is configured such that a flow rate V1 of the cooling fluid in the gas-liquid separation chamber 18 at a position (18a) where the suction hole 41 is provided is higher than a flow rate V2 of the cooling fluid in the gas-liquid separation chamber 18 at the position where the communication hole 14 is provided (see FIG. 4).

When the suction hole 41 that communicates the tank chamber 17 and the discharge pipe 16 is provided as in other embodiments described below, the reservoir tank is configured such that the flow rate V1 of the cooling fluid in the discharge pipe 16 is higher than the flow rate V2 of the cooling fluid in the gas-liquid separation chamber 18 at the position where the communication hole 14 is provided.

A specific structure of the gas-liquid separation chamber 18 and/or the discharge pipe 16 is not particularly limited for making the flow rate V1 of the cooling fluid at the position where the suction hole 41 is provided higher than the flow rate V2 of the cooling fluid at the position where the communication hole 14 is provided. For example, by adjusting the cross-sectional area (cross-sectional area in a plane parallel to a direction perpendicular to the flow) of the gas-liquid separation chamber 18 and/or the discharge pipe 16 in order to generate such a flow rate difference, the cross-sectional area of the gas-liquid separation chamber 18 may be larger than that of the discharge pipe 16. Or, in order to generate such a flow rate difference, the gas-liquid separation chamber 18 may be configured to be narrowed at a portion near the discharge pipe 16. Or, in order to generate such a flow rate difference, a rectifying plate or a baffle plate may be provided inside the gas-liquid separation chamber 18 to form a slow flow portion, and the communication hole may be formed in the portion. Or, in order to generate such a flow rate difference, a vortex may be generated inside the gas-liquid separation chamber 18, and the communication hole 14 may be provided near a center of the vortex. In the first embodiment, the shape of the gas-liquid separation chamber 18 and arrangement of the inflow pipe 15 and the discharge pipe 16 are determined so that the vortex is generated inside the gas-liquid separation chamber 18.

Although not essential, like the reservoir tank 10 of the first embodiment, it is preferable that the gas-liquid separation chamber 18 has a cylindrical wall (an outer peripheral wall 11a), and is configured to allow the cooling fluid to flow curved in an arc shape along the wall (outer peripheral wall 11a), to collect the bubbles in the cooling fluid radially inward of the arc. That is, like the reservoir tank 10 of the first embodiment, the gas-liquid separation chamber 18 preferably has a cylindrical outer peripheral wall 11a. The cylindrical outer peripheral wall 11a is formed such that a center line of cylinder extends in a substantially vertical direction. The cylindrical outer peripheral wall 11a does not need to be strictly cylindrical. The outer peripheral wall 11a may be a part of a cylindrical surface, a part of a conical surface, or a part of a torus surface. A radius of curvature of the outer peripheral wall 11a in a circumferential direction may be constant or may change.

In this case, the gas-liquid separation chamber 18 is preferably configured such that the cooling fluid fed from the inflow pipe 15 into the gas-liquid separation chamber 18 flows along the cylindrical outer peripheral wall 11a curving in an arc form so as to rotate around a vertical axis, and is guided to the discharge pipe 16. In the first embodiment, as illustrated in the cross-sectional views of FIGS. 2 and 3, the gas-liquid separation chamber 18 is formed as a flat chamber (space) extending in a substantially horizontal direction. As illustrated in FIG. 3, the gas-liquid separation chamber 18 is surrounded by a substantially D-shaped outer peripheral wall 11a when viewed in the vertical direction. Although not essential, in the first embodiment, the cylindrical outer peripheral wall 11a surrounds a right half of the gas-liquid separation chamber 18 in FIG. 3. In the gas-liquid separation chamber 18, the cooling fluid flows along a substantially horizontal plane curving in an arc form.

A specific shape of the gas-liquid separation chamber 18 and a specific arrangement of the inflow pipe 15 and the exhaust pipe 16 are not particularly limited. For example, a cross-sectional shape of the gas-liquid separation chamber 18 when viewed in the vertical direction may be circular. In the first embodiment, a mode in which the cooling fluid flowing in from the inflow pipe 15 changes its direction by about 180 degrees and flows out of the discharge pipe 16 has been described. In this regard, the flow of the cooling fluid in the gas-liquid separation chamber 18 is not particularly limited. In the reservoir tank 10 of the first embodiment, the outer peripheral wall 11a of the gas-liquid separation chamber 18 is provided in an arc shape. In this regard, an arcuate wall in the gas-liquid separation chamber 18 does not necessarily have to be the outer peripheral wall. An arcuate wall may be provided inside the gas-liquid separation chamber 18.

When the gas-liquid separation chamber 18 has a cylindrical wall and is configured to allow the cooling fluid to flow curved in an arc shape along the wall, to collect the bubbles in the cooling fluid radially inward of the arc, the communication hole 14 is preferably provided radially inward of an arcuate flow. That is, as illustrated in FIG. 3, the communication hole 14 is provided at a position closer to a central axis m of the cylindrical outer peripheral wall 11a than to the cylindrical outer peripheral wall 11a when viewed in the vertical direction. In FIG. 3, the central axis m of the cylindrical outer peripheral wall 11a is indicated by a center of gravity mark. It is preferable that the communication hole 14 includes the central axis m of the cylindrical outer peripheral wall 11a when viewed in the vertical direction.

The communication hole 14 is preferably provided radially inward of the arcuate flow when viewed from the vertical direction, that is, the reservoir tank 10 is preferably configured such that the communication hole 14 is not opened in a portion near the cylindrical outer peripheral wall 11a, and the partition wall 13 partitions the gas-liquid separation chamber 18 and the tank chamber 17, while the partition wall 13 is provided with the communication hole 14 in a portion near the central axis m of the cylindrical outer peripheral wall 11a apart from the cylindrical outer peripheral wall 11a, so that the cooling fluid and the bubbles can flow back and forth between the gas-liquid separation chamber 18 and the tank chamber 17. With this structure, the bubbles collected radially inward of the gas-liquid separation chamber 18 are easily guided into the tank chamber 17. The communication hole 14 may be a single hole or a set of a plurality of holes.

The communication hole 14 is preferably provided in the gas-liquid separation chamber 18 so as to be shifted downstream in the direction along the flow of the cooling fluid. The cooling fluid flows into the gas-liquid separation chamber 18 shown in FIG. 3 from the inflow pipe 15 connected to an upper left side of the gas-liquid separation chamber 18. Therefore, a connection portion with the inflow pipe 15 in the gas-liquid separation chamber 18 is an upstream portion of the gas-liquid separation chamber 18. Further, the cooling fluid flows out of the discharge pipe 16 connected to a lower left side of the gas-liquid separation chamber 18. Therefore, a connection portion with the discharge pipe 16 in the gas-liquid separation chamber 18 is a downstream portion of the gas-liquid separation chamber 18. Then, a portion of the gas-liquid separation chamber 18 in which the cooling fluid flows along the cylindrical outer peripheral wall 11a is a midstream portion of the gas-liquid separation chamber 18. When inside of the gas-liquid separation chamber 18 is divided into the upstream portion, the midstream portion, and the downstream portion that are continuous as described above, the communication hole 14 is preferably provided to be shifted downstream in the direction along the flow of the cooling fluid. That is, the communication holes 14 are preferably provided unevenly so that more communication holes 14 are opened midstream than upstream and more communication holes 14 are opened downstream than midstream. Although not essential, in the first embodiment, as illustrated in FIG. 3, a center O of the circular communication hole 14 is disposed on a lower left side of the central axis m of the cylindrical outer peripheral wall 11a. Thus, the communication hole 14 is provided to be shifted downstream in the direction along the flow of the cooling fluid in the gas-liquid separation chamber 18.

In the first embodiment, a material forming the reservoir tank 10 and a method for manufacturing the reservoir tank 10 are not particularly limited. The reservoir tank 10 can be manufactured by a known material and a known manufacturing method. Typically, the reservoir tank 10 is formed using a thermoplastic resin such as a polyamide resin as a main material. The material, reinforcing structure, and the like of the reservoir tank 10 are determined depending on the type, temperature, pressure, and the like of the cooling fluid to be used. Typically, the reservoir tank 10 can be manufactured by respectively forming members corresponding to the lower case 11, the upper case 12, and the partition wall 13 by injection molding, and by integrating the members by vibration welding, hot plate welding or the like.

An operation and effect of the reservoir tank 10 of the first embodiment will be described. With the reservoir tank 10 of the first embodiment, the gas-liquid separation can be efficiently performed while controlling the turbulent surface of the liquid in the tank body.

In the reservoir tank 10 of the first embodiment, as illustrated in FIG. 2, the tank chamber 17 for storing the cooling fluid, and the gas-liquid separation chamber 18 provided adjacently below the tank chamber 17 in the vertical direction are partitioned by the partition wall 13. The inflow pipe 15 and the discharge pipe 16 are connected to the gas-liquid separation chamber 18. Thus, the cooling fluid flowing in from the inflow pipe 15 flows through the gas-liquid separation chamber 18 to the discharge pipe 16. Thus, in the reservoir tank 10, a strong flow from the inflow pipe 15 hardly flows into the tank chamber 17. Therefore, even if the flow rate of the cooling fluid flowing in from the inflow pipe 15 increases, it is possible to control the turbulent surface of the liquid in the tank chamber 17 in which the cooling fluid and the air are stored. If the turbulent surface of the liquid is controlled, it gets difficult for the cooling fluid to entrain the bubbles in the tank chamber 17, so that gas-liquid separation performance is also improved.

As illustrated in FIG. 4, in the reservoir tank 10 of the first embodiment, the partition wall 13 is provided with the communication hole 14 that communicates the tank chamber 17 and the gas-liquid separation chamber 18. The reservoir tank 10 is provided with the suction hole 41 that communicates the tank chamber 17 and the vicinity 18a of the discharge pipe of the gas-liquid separation chamber 18. Further, the reservoir tank 10 is configured such that the flow rate V1 of the cooling fluid in the gas-liquid separation chamber 18 at the position where the suction hole 41 is provided is higher than the flow rate V2 of the cooling fluid in the gas-liquid separation chamber 18 at the position where the communication hole 14 is provided.

Especially in the reservoir tank 10 of the first embodiment, the gas-liquid separation chamber 18 has the cylindrical outer peripheral wall 11a, and is configured such that the cooling fluid flows curved in an arc shape along the outer peripheral wall 11a. Therefore, near the discharge port of the gas-liquid separation chamber 18, the main flow of the cooling fluid directly flows in, and the flow rate V1 increases. On the other hand, the communication hole 14 is provided radially inward of the cylindrical outer peripheral wall 11a of the gas-liquid separation chamber 18. Therefore, in the portion where the communication hole 14 exists, the cooling fluid flows slowly in a vortex shape, and the flow rate V2 decreases.

When there is such a flow rate difference between the communication hole 14 and the suction hole 41 in the gas-liquid separation chamber 18, the pressure in the suction hole 41 is lower than the pressure in the communication hole 14 according to so-called Venturi effect. As illustrated in FIG. 5, the flow of the cooling fluid that flows from the communication hole 14 to the tank chamber 17 and is sucked from the suction hole 41 to the discharge pipe 16 is caused secondarily. Due to this secondary flow, the cooling fluid containing many bubbles collected near the communication hole 14 in the gas-liquid separation chamber 18 flows into the tank chamber 17. Then, the bubbles are separated from the cooling fluid by action of the gravity or the like in the tank chamber 17. The cooling fluid with reduced bubbles is discharged through the suction hole 41 to the discharge pipe 16. Therefore, by providing the communication hole 14 and the suction hole 41 at portions where there is a difference in the flow rate of the cooling fluid, the cooling fluid containing many bubbles in the gas-liquid separation chamber 18 is allowed to flow into the tank chamber 17 while the cooling fluid from which the bubbles have been removed can be circulated to the discharge pipe 16 through the suction hole 41. Therefore, the gas-liquid separation can be efficiently performed.

In the reservoir tank 10, the gas-liquid separation chamber 18 is provided adjacently below the tank chamber 17 in the vertical direction. Further, the communication hole 14 is provided in the partition wall 13 that partitions the tank chamber 17 and the gas-liquid separation chamber 18. This makes it possible to utilize the gravity to collect the bubbles in the gas-liquid separation chamber 18 toward the partition wall 13 and the communication hole 14. Therefore, these facts also contribute to efficient gas-liquid separation because they promote the bubbles to move to the tank chamber 17.

Although not essential, in the reservoir tank 10 of the first embodiment, the gas-liquid separation chamber 18 has the cylindrical outer peripheral wall 11a, and is configured to allow the cooling fluid to flow curved in an arc shape along the outer peripheral wall 11a. Thus, when the gas-liquid separation chamber 18 is configured to collect the bubbles in the cooling fluid radially inward of the arc, and the communication hole 14 is provided radially inward of the arc, the separation of the bubbles in the gas-liquid separation chamber 18 is promoted by the action of the centrifugal force. Therefore, the gas-liquid separation effect can be further enhanced.

That is, in the gas-liquid separation chamber 18, the cooling fluid is allowed to flow curved in an arc shape along the outer peripheral wall 11a, so that the centrifugal force acts on the cooling fluid. When the centrifugal force acts on the cooling fluid containing the bubbles, bubbles B, B tend to collect in a radially inner portion of the cylindrical outer peripheral wall 11a. On the other hand, the cooling fluid that does not contain the bubbles B, B so much tends to collect in a radially outer portion of the cylindrical outer peripheral wall 11a. That is, in the flow of the cooling fluid along the cylindrical outer peripheral wall 11a in the gas-liquid separation chamber 18, the bubbles B, B increase at the portion near the central axis m of the cylindrical outer peripheral wall 11a as it flows downstream, while the bubbles B, B decrease in a portion adjacent to the cylindrical outer peripheral wall 11a. As a result, in the gas-liquid separation chamber 18, the bubbles in the cooling fluid are collected radially inward of the arc.

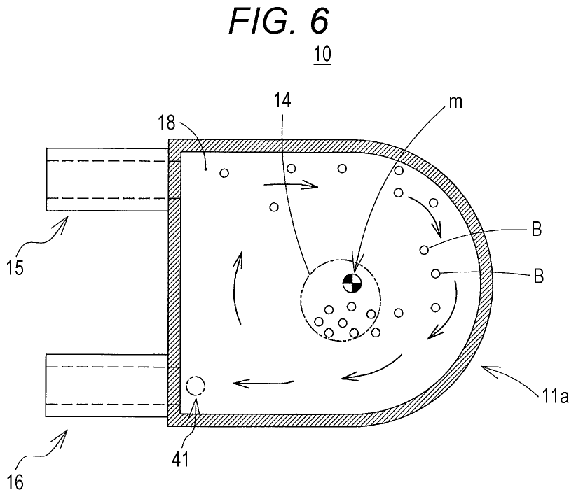

As illustrated in FIG. 6, the communication hole 14 provided in the partition wall 13 is provided radially inward of the arc. Therefore, the cooling fluid containing the bubbles B, B collected radially inward of the circular arc by the centrifugal force is guided to the tank chamber 17 through the communication hole 14. The communication hole 14 is particularly preferably provided near the central axis m of the arc.

In the gas-liquid separation chamber 18, the cooling fluid with reduced bubbles B, B flows in the portion adjacent to the cylindrical outer peripheral wall 11a, and is discharged from the discharge pipe 16.

That is, in the reservoir tank 10 of the first embodiment, the bubbles B, B in the cooling fluid are collected by the gas-liquid separation chamber 18 having a function of separating gas and liquid by the centrifugal force. Thus, the cooling fluid with many bubbles flows through the communication hole 14 to the tank chamber 17, and the bubbles are separated from the cooling fluid in the tank chamber 17. On the other hand, the cooling fluid with reduced bubbles is discharged outwardly through the discharge pipe 16. Therefore, the gas-liquid separation efficiency of the reservoir tank 10 is particularly increased.

Although not essential, from the viewpoint of enhancing the gas-liquid separation effect while controlling the turbulent surface of the liquid inside the tank chamber 17, like the reservoir tank 10 of the first embodiment, it is preferable that the cross-sectional area of the flow path of the discharge pipe 16 or of the gas-liquid separation chamber 18 at the position where the suction hole 41 is provided is larger than that of the suction hole 41. Thus, there is a high possibility that a secondary flow of the cooling fluid flowing from the tank chamber 17 through the suction hole 41 to the gas-liquid separation chamber 18 or the discharge pipe 16 occurs. Therefore, even if the flow rate of the cooling fluid to the reservoir tank 10 changes, this secondary flow is unlikely to flow backward. Further, since the cross-sectional area of the suction hole 41 is relatively small, the secondary flow of the cooling fluid flowing from the communication hole 14 into the tank chamber 17 and returning from the suction hole 41 is gentle. Therefore, even if the flow rate of the cooling fluid flowing from the inflow pipe 15 into the reservoir tank is high, it is possible to more effectively control the turbulent surface of the liquid inside the tank chamber 17.

Although not essential, from the viewpoint of enhancing the gas-liquid separation effect while controlling the turbulent surface of the liquid inside the tank chamber 17, like the reservoir tank 10 of the first embodiment, it is preferable that the cross-sectional area of the suction hole 41 is smaller than that of the communication hole 14. Thus, the flow rate of the secondary flow of the cooling fluid flowing from the communication hole 14 into the tank chamber 17 and returning through the suction hole 41 is reduced when flowing into the tank chamber 17 from the communication hole 14. Thus, even if the flow rate of the cooling fluid flowing into the reservoir tank 10 is high, it is possible to more effectively control the turbulent surface of the liquid inside the tank chamber 17. Further, since large opening of the communication hole 14 facilitates the bubbles B collected in the upper portion of the gas-liquid separation chamber 18 to be guided into the tank chamber 17, it is also effective from the viewpoint of enhancing the gas-liquid separation performance.

The aspects of the present disclosure are not limited to the above embodiments, but can be implemented with various modifications. Hereinafter, other embodiments of the present disclosure will be described. In the following description, portions different from the above embodiment will be mainly described, and the same portions will be denoted by the same reference numerals and detailed description thereof will be omitted. Further, the embodiments can be implemented by combining some of them or replacing some of them.

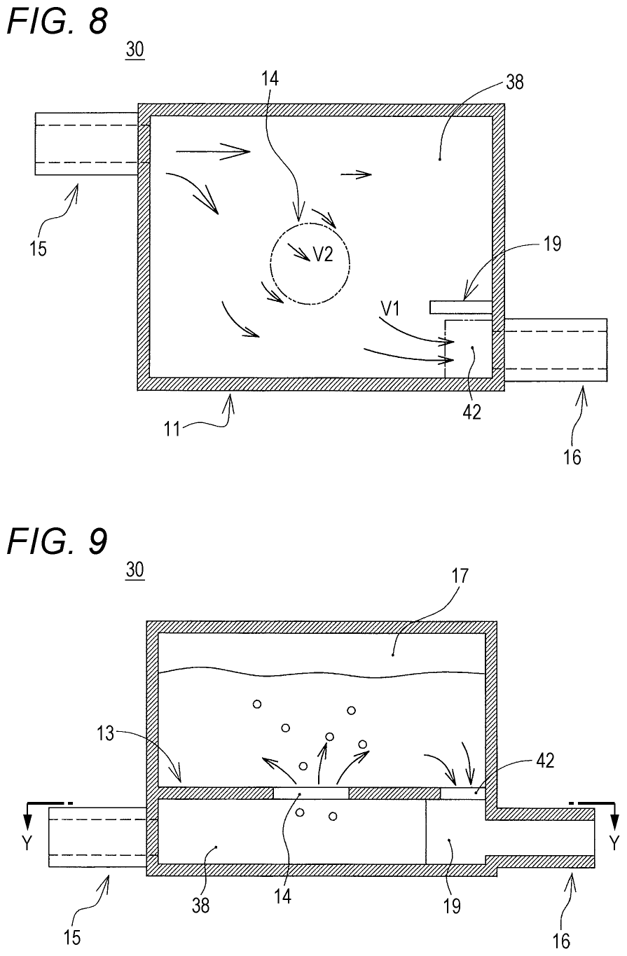

FIGS. 7, 8 and 9 illustrates a reservoir tank 30 of a second embodiment. FIG. 7 is an exploded perspective view of the reservoir tank 30. FIG. 8 is a cross-sectional view of the gas-liquid separation chamber 18 taken along a line Y-Y (see FIG. 9) when viewed from the vertical direction. FIG. 9 is a cross-sectional view of the reservoir tank 30 taken along a line X-X (see FIG. 7).

The reservoir tank 30 of the second embodiment is different from the reservoir tank 10 of the first embodiment in the structure of the gas-liquid separation chamber 38, the arrangement of the discharge pipe 16, and the structure around the suction hole 41. On the other hand, other structures of the reservoir tank 30 are the same as those of the reservoir tank 10 of the first embodiment.

As illustrated in FIG. 8, in the reservoir tank 30 of the second embodiment, the gas-liquid separation chamber 38 has a rectangular parallelepiped shape. In the second embodiment, the gas-liquid separation chamber 38 does not have a cylindrical wall. Further, in the second embodiment, the inflow pipe 15 and the exhaust pipe 16 are provided to be diagonal to each other when the gas-liquid separation chamber 38 is viewed in the vertical direction.

A partition wall 19 is provided at a portion of the gas-liquid separation chamber 38 connected to the discharge pipe 16. Therefore, the gas-liquid separation chamber 38 and the discharge pipe 16 have a structure in which the discharge pipe 16 is substantially extended inwardly of the gas-liquid separation chamber 38. Further, the suction hole 42 in the present embodiment is provided to have a shape formed by cutting out a corner portion of the partition wall 13. In the second embodiment, the suction hole 42 substantially communicates the tank chamber 17 and the discharge pipe 16.

As in the second embodiment, the suction hole 42 may be a hole that communicates the tank chamber 17 and the discharge pipe 16. Like the reservoir tank 10 of the first embodiment, the suction hole 42 can control the turbulent surface of the liquid inside the tank chamber 17 and enhance the gas-liquid separation effect. That is, as illustrated in FIG. 8, in the second embodiment, the cooling fluid flows from the inflow pipe 15 into the gas-liquid separation chamber 38. The gas-liquid separation chamber 38 is widened and expanded to have a rectangular parallelepiped shape. Thus, in the gas-liquid separation chamber 38, the flow of the cooling fluid is diffused and the flow rate of the cooling fluid is slow. Therefore, the flow rate V2 of the cooling fluid near the communication hole 14 in the gas-liquid separation chamber 38 is low. On the other hand, in a portion where the suction hole 42 is provided in the gas-liquid separation chamber 38, the flow path is narrowed by the partition wall 19 to substantially the same extent as the discharge pipe 16. Therefore, the flow rate V1 of the cooling fluid in this portion is relatively high.

Due to such a difference in the flow rate between the communication hole 14 and the suction hole 42, a pressure difference due to the Venturi effect occurs, and the pressure of the suction hole 42 is lower than that of the communication hole 14. Therefore, as shown in FIG. 9, the secondary flow of the cooling fluid occurs from the communication hole 14 through the tank chamber 17, and from the suction hole 42 to the discharge pipe 16. Inside the gas-liquid separation chamber 38, the bubbles are collected in the upper portion of the gas-liquid separation chamber 38 mainly by the action of gravity. In the second embodiment, the bubbles near the communication hole 14 are guided to the tank chamber 17 by the secondary flow, and the bubbles are separated from the cooling fluid in the tank chamber 17. Therefore, even in the reservoir tank 30 of the second embodiment, it is possible to enhance the gas-liquid separation effect while controlling the turbulent surface of the liquid inside the tank chamber 17.

When the separation of the bubbles in the gas-liquid separation chamber 38 is solely by the action of gravity as in the reservoir tank 30 of the second embodiment, it is preferable that the partition wall 13 is provided to have a conical surface shape that goes vertically upward as it goes to the communication hole 14 from the outer peripheral portion of the partition wall 13. With such a structure, the bubbles in the gas-liquid separation chamber 38 can be efficiently collected around the communication hole 14. Therefore, the gas-liquid separation effect can be further enhanced.

FIG. 10 illustrates a reservoir tank 40 of a third embodiment. FIG. 10 is a vertical cross-sectional view (cross-sectional view taken along the line X-X) of the reservoir tank 40, and corresponds to FIG. 9 in the second embodiment.

The reservoir tank 40 of the third embodiment is different from the reservoir tank 30 of the second embodiment in the structure of the gas-liquid separation chamber 38 and the structure around the suction hole 41. Other structures of the reservoir tank 40 are the same as those of the reservoir tank 30 of the second embodiment.

In the reservoir tank 40 of the third embodiment, a suction hole 43 communicates the tank chamber 17 and the discharge pipe 16. In this way, the tank chamber 17 and the discharge pipe 16 may be directly communicated with each other through the suction hole 43. Or, like the reservoir tank 10 of the first embodiment, the tank chamber 17 and the vicinity of the discharge pipe 16 of the gas-liquid separation chamber 18 may be communicated through the suction hole 41. Also in the third embodiment, the reservoir tank 40 is configured such that the flow rate (V1) of the cooling fluid in the discharge pipe 16 or in the gas-liquid separation chamber 18 at the position where the suction hole 43 is provided is higher than the flow rate (V2) of the cooling fluid in the gas-liquid separation chamber 18 at the position where the communication hole 14 is provided. Thus, the secondary flow of the cooling fluid flowing from the communication hole 14 to the discharge pipe 16 through the tank chamber 17 and the suction hole 43 occurs. Therefore, the efficient gas-liquid separation is performed.

Although not essential, in the reservoir tank 40 of the third embodiment, the suction hole 43 is provided in a tubular shape, that is, a pipe shape. Even such a tubular suction hole 43 contributes to enhancement of the gas-liquid separation effect, like the suction holes of other shapes. The specific structure of the tubular or pipe-shaped suction hole 43 is not particularly limited. The suction hole 43 may be realized (formed) by using a pipe made of resin or metal. Or, the tubular suction hole 43 may be realized (formed) by a tank wall surface of the reservoir tank 40 and the partition wall 13.

FIG. 11 illustrates a reservoir tank 50 of a fourth embodiment. FIG. 11 is a vertical cross-sectional view (cross-sectional view taken along the line X-X) of the reservoir tank 50, and corresponds to FIG. 9 in the second embodiment.

The reservoir tank 50 of the fourth embodiment is different from the reservoir tank 30 of the second embodiment in the structure of the partition wall 53 that separates the gas-liquid separation chamber 58 and the tank chamber 17, and a structure around a suction hole 44. Other structures of the reservoir tank 50 are the same as those of the reservoir tank 30 of the second embodiment.

Although not essential, in the reservoir tank 50 of the fourth embodiment, the partition wall 53 is provided in a shape having a step so that height of the gas-liquid separation chamber 58 is high near the communication hole 14 and is low near the suction hole 44. The partition wall 53 having the step is provided so that the height of the gas-liquid separation chamber 58 is reduced just before the discharge pipe 16. The suction hole 44 is provided in the reduced portion of the gas-liquid separation chamber 58. Accordingly, a cross-sectional area FS1 of the flow path of the discharge pipe 16 or the gas-liquid separation chamber 58 at the position where the suction hole 44 is provided, which is measured in the cross-section perpendicular to the flow direction of the cooling fluid, is smaller than a cross-sectional area FS2 of the gas-liquid separation chamber 58 at the position where the communication hole 14 is provided, which is measured in the cross-section.

As described above, in the reservoir tank 50 of the fourth embodiment, the cross-sectional area FS1 of the flow path of the discharge pipe 16 or the gas-liquid separation chamber 58 at the position where the suction hole 44 is provided, which is measured in the cross-section perpendicular to the flow direction of the cooling fluid, is smaller than the cross-sectional area FS2 of the gas-liquid separation chamber 58 at the position where the communication hole 14 is provided, which is measured in the cross section. Thus, there is a high possibility that the flow rate V1 of the cooling fluid in the discharge pipe 16 or in the gas-liquid separation chamber 58 at the position where the suction hole 44 is provided is higher than the flow rate V2 of the cooling fluid in the gas-liquid separation chamber 58 at the position where the communication hole 14 is provided. Thus, the bubbles are effectively separated from the cooling fluid.

As seen in the first to the fourth embodiments, a specific form of the suction hole is not particularly limited. The suction hole may be formed by forming a hole in the partition wall, or may have a tubular shape. Or, the suction hole may be configured to directly communicate the tank chamber 17 and the discharge pipe 16. Or, the suction hole may be configured to communicate the tank chamber 17 and the vicinity of the discharge pipe 16 of the gas-liquid separation chamber. In any of the forms of the suction holes, the gas-liquid separation can be performed while controlling the turbulent surface of the liquid inside the tank body.

From the viewpoint of increasing the efficiency of gas-liquid separation, in any of the reservoir tanks of the embodiments, the partition wall 13 is preferably provided to have the conical surface shape that goes vertically upward as it goes to the communication hole 14 from the outer peripheral portion of the partition wall 13. With such a structure, by the action of gravity in the gas-liquid separation chamber 18, the bubbles moving vertically upward are guided to the communication hole 14 and the tank chamber 17, and are easily separated from the cooling fluid.

In examples shown in the above embodiments, the communication hole 14 is a through-hole-shaped hole provided in a plate-like partition wall 13. In this regard, the specific shape of the communication hole 14 is not particularly limited. As long as the tank chamber 17 and the discharge pipe 16 can be communicated with each other, the communication hole 14 may be a hole formed in a pipe shape.

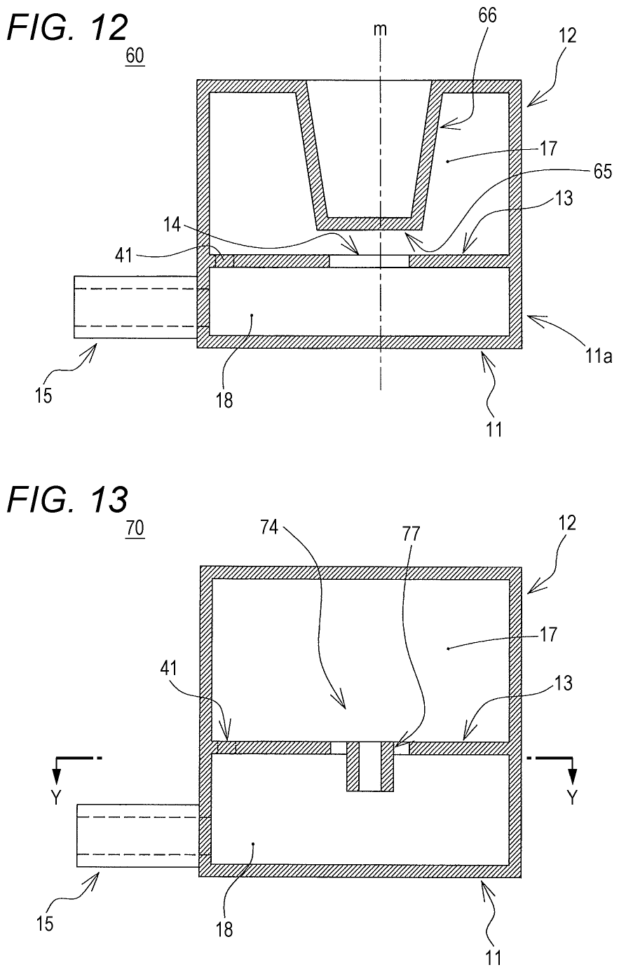

FIG. 12 illustrates a reservoir tank 60 of a fifth embodiment. FIG. 12 is a cross-sectional view taken along the line X-X, corresponding to FIGS. 2, 9, 10 and 11 of other embodiments. FIG. 12 illustrates a cross-sectional structure of the reservoir tank 60. The reservoir tank 60 of the fifth embodiment further includes a control surface 65 and a support portion 66 in the tank chamber 17 as compared with the reservoir tank 10 of the first embodiment. Other structures of the reservoir tank 50 are the same as those of the reservoir tank 10 of the first embodiment.

In the reservoir tank 60 of the fifth embodiment, the control surface 65 is provided to face the communication hole 14 at a predetermined interval inside the tank chamber 17. The control surface 65 is provided to control the flow of the cooling fluid, that flows from the gas-liquid separation chamber 18 into the tank chamber 17 through the communication hole 14 and flows upward of the tank chamber 17, to be a flow flowing in a lateral direction. The control surface 65 may be a plate or a block made of a material such as metal or resin that does not easily transmit liquid. The control surface 65 may be formed using a mesh material, a nonwoven fabric, a foam, or the like. In the fifth embodiment, the control surface 65 that does not easily transmit liquid is provided by using a plate material made of a thermoplastic resin.

The control surface 65 is provided such that the cooling fluid flowing into the tank chamber 17 from the communication hole 14 flows in the horizontal direction, preferably to cover the entire communication hole 14, that is, the control surface 65 is provided in the same size as or larger than the communication hole 14 when viewed in the vertical direction. The shape of the control surface 65 is not particularly limited. The shape of the control surface 65 is preferably a flat plate extending in a substantially horizontal direction as in the fifth embodiment.

The control surface 65 is supported by the support portion 66 on the upper case 12 constituting the tank chamber 17. The specific shape of the support portion 66 is not particularly limited as long as the control surface 65 can be properly supported. In the fifth embodiment, the support portion 66 is formed in a cylindrical shape. The outer periphery of the control surface 65 is supported by the support portion 66. Such a form is advantageous when the upper case 12 is injection-molded. The support portion 66 may support the control surface 65 on an upper surface (top surface) of the upper case 12 or may support the control surface 65 on a side surface (an outer surface) of the upper case 12. Or, a support portion that supports the control surface 65 on the partition wall 13 may be provided to integrally mold the partition wall 13 and the control surface 65. When a cap or a valve body is provided in the reservoir tank 60, the control surface 65 may be provided on the cap or the valve body. In this case, the support portion 66 may be omitted.

In the reservoir tank 60 of the fifth embodiment, the control surface 65 is provided to face the communication hole 14 at the predetermined interval inside the tank chamber 17. Further, the flow of the cooling fluid flowing from the gas-liquid separation chamber 18 into the tank chamber 17 through the communication hole 14 and flowing upward of the tank chamber 17 is controlled to be the flow flowing in the lateral direction. Thus, even when the flow rate of the cooling fluid is increased and the cooling fluid flows vigorously into the tank chamber 17 through the communication hole 14, since the turbulent surface of the liquid inside the tank chamber 17 can be controlled, the bubbles are suppressed from being entrained in the cooling fluid. That is, the cooling fluid flowing into the tank chamber 17 through the communication hole 14 does not directly flow upward in the tank chamber 17 but is once diffused and flows in the lateral direction by the control surface 65. Therefore, since the flow of the cooling fluid flowing into the tank chamber 17 is diffused laterally and weakened, it is difficult to induce the turbulent surface of the liquid in the tank chamber 17. Therefore, in the reservoir tank 60 of the fifth embodiment, the effect of controlling the turbulent surface of the cooling fluid in the tank chamber 17 is particularly enhanced.

When the control surface 65 is provided inside the tank chamber 17 like the reservoir tank 60 of the fifth embodiment, it is preferable to avoid the flow of the cooling fluid flowing laterally from the control surface 65 from flowing toward the suction hole 41. It is particularly preferred to allow the flow of the cooling fluid flowing laterally from the control surface 65 to flow in a direction opposite to the suction hole 41. This further enhances the gas-liquid separation performance.

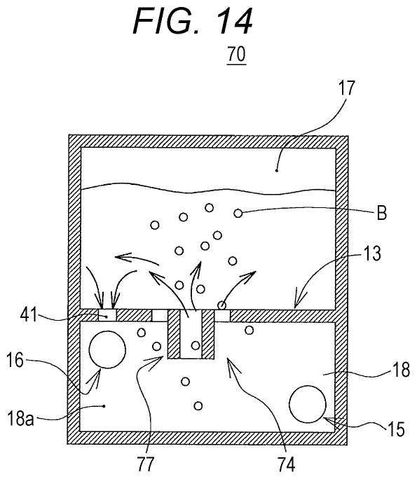

FIGS. 13 and 14 illustrate a reservoir tank 70 of a sixth embodiment. In the reservoir tank 70 of the sixth embodiment, a communication hole 74 is configured to include a pipe 77 as compared with the reservoir tank 10 of the first embodiment described with reference to FIGS. 1 to 6. Further, a value of height of the gas-liquid separation chamber 18 is set to be larger than any of diameters of the inflow pipe 15 and the discharge pipe 16. A position where the discharge pipe 16 is provided is set vertically higher than a position where the inflow pipe 15 is provided. Other structures of the reservoir tank 70 are the same as those of the reservoir tank 10 of the first embodiment. FIG. 13 is a cross-sectional view taken along the line X-X, corresponding to FIGS. 2, 9, 10, 11 and 12 of other embodiments. FIG. 13 illustrates a vertical cross-sectional structure of the reservoir tank 70. FIG. 14 is a cross-sectional view taken along a line A-A (see FIG. 4) corresponding to FIG. 5 of the first embodiment.

In the reservoir tank 70 of the sixth embodiment, the communication hole 74 provided in the partition wall 13 is provided to include the pipe 77. That is, the communication hole 74 is configured such that a hollow tubular pipe 77 substantially vertically projects inwardly of the gas-liquid separation chamber 18 inside the through-hole provided in the plate-shaped partition wall 13. Although not essential, in the sixth embodiment, the pipe 77 is integrated with the partition wall 13 with a rib or the like. In the sixth embodiment, the pipe 77 is provided substantially at center of the through-hole. Instead of this, the pipe 77 may be provided at a peripheral portion of the through-hole. Or, the communication hole 74 may be provided such that the pipe 77 and the through-hole are arranged side by side.

With the structure of the communication hole 74, a portion of the through-hole between the partition wall 13 and the pipe 77 communicates a portion near the partition wall of the gas-liquid separation chamber 18 with the tank chamber 17. On the other hand, a pipe line of the pipe 77 communicates a central portion of the gas-liquid separation chamber 18 in a height direction, which is downwardly distant from the partition wall 13, with the tank chamber 17.

As illustrated in FIG. 14, when the cooling fluid flows into the reservoir tank 70 of the sixth embodiment, the cooling fluid flows from the gas-liquid separation chamber 18 to the tank chamber 17 through the communication hole 74. Further, the secondary flow of the cooling fluid flowing from the tank chamber 17 to the gas-liquid separation chamber 18 through the suction hole 41 is generated. Then, from the through-hole of the communication hole 74, the cooling fluid containing many bubbles collected in an upper portion of the gas-liquid separation chamber 18 (near the partition wall 13) can be guided to the tank chamber 17. On the other hand, the cooling fluid can be guided to the tank chamber 17 by the pipe 77 from a position downwardly distant from the partition wall 13.

As described above, the reservoir tank 70 of the sixth embodiment includes the gas-liquid separation chamber 18 that separates the bubbles using both the centrifugal force and the gravity. In the reservoir tank 70 having such a structure, the bubbles gather at center of an arc-shaped flow and center of a vortex generated in the gas-liquid separation chamber 18 and move upward. However, when a bubble diameter is small, the bubbles hardly move upward, and fine bubbles are likely to remain in a tornado shape at the center of the arc-shaped flow and the center of the vortex in the gas-liquid separation chamber 18. When the pipe 77 is provided, the cooling fluid in which a lot of such fine bubbles are collected can be effectively sent into the tank chamber 17 from a position away from the partition wall 13. Therefore, the fine bubbles can be separated in the tank chamber 17. That is, when the communication hole 74 provided in the partition wall 13 is provided to include the pipe 77 as in the sixth embodiment, the cooling fluid can be guided to the tank chamber 17 from a portion in the gas-liquid separation chamber 18 where the air bubbles are likely to remain. Therefore, the gas-liquid separation performance of the reservoir tank 70 can be further improved.

The reservoir tank according to the embodiment of the present disclosure may have other structures. For example, the reservoir tank may be provided with a removable cap. Through such a cap, the cooling fluid can be filled in the tank or the cooling fluid circuit. Further, a stay or a boss member for attaching the reservoir tank to a vehicle body or the like may be integrated with the reservoir tank as necessary. Furthermore, the reservoir tank may be provided with a reinforcing structure such as a rib depending on a pressure resistance required for the reservoir tank.

The reservoir tank according to the embodiments of the present disclosure can be used in the cooling fluid circuit of the cooling system. The reservoir tank according to the embodiments of the present disclosure can separate the bubbles in the cooling fluid, and thus has a high industrial utility value.

Further, the reservoir tank according to the embodiments of the present disclosure may be the following first reservoir tanks.

The first reservoir tank is a reservoir tank provided in the cooling fluid circuit of the liquid-cooled cooling system, and includes: a tank chamber for storing a cooling fluid; a gas-liquid separation chamber provided adjacently below the tank chamber in a vertical direction; a partition wall for partitioning the tank chamber and the gas-liquid separation chamber; an inflow pipe for sending the cooling fluid into the reservoir tank; and a discharge pipe for discharging the cooling fluid from the reservoir tank. The inflow pipe and the discharge pipe are connected to the gas-liquid separation chamber, the partition wall is provided with a communication hole that communicates the tank chamber and the gas-liquid separation chamber, the reservoir tank is provided with a suction hole that communicates the tank chamber and the discharge pipe, or a suction hole that communicates the tank chamber and a vicinity of the discharge pipe in the gas-liquid separation chamber, and a flow rate of the cooling fluid in the discharge pipe or in the gas-liquid separation chamber at a position where the suction hole is provided is higher than the flow rate of the cooling fluid in the gas-liquid separation chamber at a position where the communication hole is provided.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A reservoir tank comprising:
a tank chamber for storing a cooling fluid;
a gas-liquid separation chamber provided adjacently below the tank chamber in a vertical direction;
a partition wall for partitioning the tank chamber and the gas-liquid separation chamber;
an inflow pipe for sending the cooling fluid into the reservoir tank; and
a discharge pipe for discharging the cooling fluid from the reservoir tank, wherein
the inflow pipe and the discharge pipe are connected to the gas-liquid separation chamber,
the partition wall is provided with a communication hole that communicates the tank chamber and the gas-liquid separation chamber,
the reservoir tank is provided with a suction hole that communicates the tank chamber and the discharge pipe, or a suction hole that communicates the tank chamber and a vicinity of the discharge pipe in the gas-liquid separation chamber, and
the reservoir tank is configured such that a flow rate of the cooling fluid in the discharge pipe or in the gas-liquid separation chamber at a position where the suction hole is provided is higher than the flow rate of the cooling fluid in the gas-liquid separation chamber at a position where the communication hole is provided.

2. The reservoir tank according to claim 1, wherein a cross-sectional area of a flow path of the discharge pipe or the gas-liquid separation chamber at the position where the suction hole is provided, which is measured in a cross-section perpendicular to a flow direction of the cooling fluid, is smaller than a cross-sectional area of the gas-liquid separation chamber at the position where the communication hole is provided, which is measured in the cross-section.

3. The reservoir tank according to claim 1, wherein a cross-sectional area of a flow path of the discharge pipe or the gas-liquid separation chamber at the position where the suction hole is provided is larger than a cross-sectional area of the suction hole.

4. The reservoir tank according to claim 1, wherein a cross-sectional area of the suction hole is smaller than that of the communication hole.

5. The reservoir tank according to claim 1, wherein
the gas-liquid separation chamber has a cylindrical wall, and is configured to allow the cooling fluid to flow curved in an arc shape along the wall, to collect air bubbles in the cooling fluid radially inward of the arc, and
the communication hole is provided radially inward of the arc.

6. The reservoir tank according to claim 1, wherein a control surface, that controls a flow of the cooling fluid flowing from the gas-liquid separation chamber into the tank chamber through the communication hole and flowing upward of the tank chamber to be a flow in a lateral direction, is provided to face the communication hole at a predetermined interval inside the tank chamber.
